(19) United States
(12) Patent Application Publication
(10) Pub. No.: US 2024/0353591 A1
(43) Pub. Date: Oct. 24, 2024

(54) GRAPHENE-BASED OPTICAL BISTABLE DEVICE WITH TERNARY PHOTONIC CRYSTAL STRUCTURE

(71) Applicant: Anhui University, Hefei (CN)

(72) Inventors: Wei CHEN, Hefei (CN); Weisen LI, Hefei (CN); Qingqing DENG, Hefei (CN); Lixia YANG, Hefei (CN)

(21) Appl. No.: 18/616,393

(22) Filed: Mar. 26, 2024

(30) Foreign Application Priority Data
Apr. 18, 2023 (CN) 202310410613.1

(51) Int. Cl. G02B 1/00; G02F 3/02

(52) U.S. Cl. CPC G02B 1/005; G02F 3/024; G02F 2202/32

(57) ABSTRACT

The present disclosure relates to the technical field of terahertz-band optical bistable devices, and provides a graphene-based optical bistable device with a ternary photonic crystal structure. The optical bistable device includes a composite structure suitable for a terahertz band, where the composite structure is formed by a ternary photonic crystal structure, a defect layer C, and a graphene layer G through permutation and combination; and the ternary photonic crystal structure is formed by three alternately-arranged dielectric layers A, B, and P with different dielectric constants, two defect layers C are embedded in the ternary photonic crystal structure, and the graphene layer G is embedded between the two defect layers C. The composite structure is Air/(ABP)^{N1}CG^{M}C(ABP)^{N2}/Air the dielectric layer A is made of a ZrO₂ material, the dielectric layer B is made of a Si material, and the dielectric layer P is made of an anisotropic plasma material.

### CROSS REFERENCE TO RELATED APPLICATION

This patent application claims priority to Chinese Patent Application No. 202310410613.1, filed with the China National Intellectual Property Administration on Apr. 18, 2023, the disclosure of which is incorporated by reference herein in its entirety as part of the present application.

### TECHNICAL FIELD

The present disclosure relates to the technical field of terahertz-band optical bistable devices, and specifically, to a graphene-based optical bistable device with a ternary photonic crystal structure.

### BACKGROUND

Optical bistability is a nonlinear effect generated through interaction between light of a certain intensity and a dielectric, which means that there are two output states for one input state. The optical bistability has two stable states with strong resolving power, which can be controlled by an optical signal. Bistability of light is considered as a kind of feedback control of a nonlinear dielectric over the light.

The optical bistability is widely used in all-optical switches, photodiodes, sensors, and memories. In a method, a lower threshold is achieved to reduce a power consumption. In another method, a large threshold interval is maintained to avoid a misoperation. Due to a working principle of an optical bistable device, reducing an excitation threshold is beneficial for reducing laser power of exciting a bistable phenomenon, thereby reducing the power consumption. More distinct high and low states and a large threshold width are beneficial for avoiding the misoperation.

There are usually two methods for designing low-threshold optical bistability: enhancing a structural local field and adopting a strong nonlinear dielectric material. In recent years, researchers have focused on unique properties of graphene and found that the graphene has a stronger third-order nonlinear effect than a traditional nonlinear Kerr dielectric material. In addition, the graphene is characterized by an ultrafast light response, variable gate conductivity, and a small size. Therefore, the graphene has become a new material for making a tunable and low-threshold optical device. For example, a modulator with an adjustable metamaterial depth can be made based on the graphene. Among current numerous studies, there are many optical bistable theory studies based on a photonic crystal structure, providing more possibilities for designing the optical bistable device. Although there are numerous research achievements on the optical bistability, existing optical bistable devices still need to be improved in terms of practicality, a low threshold, and a plurality of control parameters.

### SUMMARY

An objective of the present disclosure is to provide a graphene-based optical bistable device with a ternary photonic crystal structure, to resolve the problems described in BACKGROUND.

To achieve the above objective, the present disclosure provides a following technical solution: A graphene-based optical bistable device with a ternary photonic crystal structure includes a composite structure suitable for a terahertz band, where the composite structure is formed by a ternary photonic crystal structure, a defect layer C, and a graphene layer G through permutation and combination; and

the ternary photonic crystal structure is a periodic photonic crystal structure formed by three alternately-arranged dielectric layers A, B, and P with different dielectric constants, two defect layers C are embedded in the ternary photonic crystal structure, and the graphene layer G is embedded between the two defect layers C; where

the composite structure is Air/(ABP)^{N1}CG^{M}C(ABP)^{N2}/Air where M, N₁, and N₂ each represent a quantity of spatial cycles, the dielectric layer A is made of a ZrO₂ material, the dielectric layer B is made of a Si material, and the dielectric layer P is made of an anisotropic plasma material.

Preferably, the defect layer C is filled with air and has a refractive index of n₀=1.

Preferably, a relative dielectric constant of the dielectric layer A is εₐ=4.21, a relative dielectric constant of the dielectric layer B is ε_{b}=7.95, and a relative dielectric constant of the dielectric layer P is

$${ε}_{p} = \frac{{[ ω ( ω + {iv}_{c} ) - {ω}_{p}^{2} ]}^{2} - {ω}_{c}^{2} {ω}^{2}}{{ω}^{2} [ ( ω + {iv}_{c} ) - {ω}_{c}^{2} ] - ω {ω}_{p}^{2} ( ω + {iv}_{c} )} ;$$

where i represents an imaginary unit, where i²=−1; ω represents an incident angle frequency;

$${ω}_{p} = \sqrt{\frac{{n}_{e} {e}^{2}}{m {ε}_{0}}}$$

represents a plasma frequency, where nₑ represents a plasma density, e represents a quantity of electron charges, m represents an electron mass, and ε₀ represents a vacuum dielectric constant; v_{c} represents a plasma collision frequency;

$${ω}_{c} = \frac{eB}{m}$$

represents an electron cyclotron frequency; and B represents a magnetic field intensity.

Preferably, thicknesses of the layers in the composite structure are respectively as follows: dₐ=30 um, d_{b}=21.28 um, dₚ=60 um, d_{c}=30 um, and d_{g}=0.33 nm; and

M=1, N₁=2, and N₂=3.

Preferably, thresholds and a threshold difference of the bistable device are controlled by a Fermi level, relaxation time, and a layer quantity of the graphene layer G.

Preferably, thresholds and a threshold difference of the bistable device are controlled by a plasma electron density of the dielectric layer P.

Preferably, thresholds and a threshold difference of the bistable device are controlled by an incident angle of an electromagnetic wave.

Compared with the prior art, the present disclosure has following beneficial effects: Through permutation and combination, the present disclosure is formed by the ternary photonic crystal structure, the defect layer, and the graphene layer embedded between the defect layers. Lower-threshold optical bistability is achieved based on a defect mode of the composite structure and a strong third-order nonlinear effect of graphene. Two metamaterials, namely, a plasma and the graphene, in the composite structure provide more control parameters for tuning optical bistability, thereby tuning the optical bistability by using a physical parameter of the plasma, a physical parameter of the graphene, and the incident angle of the electromagnetic wave. With advantages of a low threshold and lots of parameters that can be used to control the optical bistability, the present disclosure has stable working performance and a broad application prospect in terahertz-band devices.

### BRIEF DESCRIPTION OF THE DRAWINGS

FIG. 1 is a schematic structural diagram of an optical bistable device according to the present disclosure;

FIG. 2A is a photonic bandgap diagram of a periodic structure of a one-dimensional ternary photonic crystal according to the present disclosure;

FIG. 2B is a photonic bandgap diagram after a defect layer is added to a periodic structure of a one-dimensional ternary photonic crystal according to the present disclosure;

FIG. 2C is a photonic bandgap diagram of a structure of an optical bistable device according to the present disclosure;

FIG. 3 shows an electric field distribution of a composite structure of a ternary photonic crystal according to the present disclosure;

FIG. 4A shows changes of a relationship between a transmitted electric field and an incident electric field in the case of different Fermi levels of graphene according to the present disclosure;

FIG. 4B shows changes of a relationship between reflectivity and an incident electric field in the case of different Fermi levels of graphene according to the present disclosure;

FIG. 5A shows changes of a relationship between a transmitted electric field and an incident electric field in the case of different relaxation time of graphene according to the present disclosure;

FIG. 5B shows changes of a relationship between reflectivity and an incident electric field in the case of different relaxation time of graphene according to the present disclosure;

FIG. 6A shows changes of a relationship between a transmitted electric field and an incident electric field in the case of different film layer quantities of graphene according to the present disclosure;

FIG. 6B shows changes of a relationship between reflectivity and an incident electric field in the case of different film layer quantities of graphene according to the present disclosure;

FIG. 7A shows changes of a relationship between a transmitted electric field and an incident electric field in the case of different plasma electron densities according to the present disclosure;

FIG. 7B shows changes of a relationship between reflectivity and an incident electric field in the case of different plasma electron densities according to the present disclosure;

FIG. 8A shows changes of a relationship between a transmitted electric field and an incident electric field in the case of different incident angles according to the present disclosure; and

FIG. 8B shows changes of a relationship between reflectivity and an incident electric field in the case of different incident angles according to the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All the other embodiments derived by those of ordinary skill in the art based on the embodiments of the present disclosure without creative efforts shall fall within the protection scope of the present disclosure.

### Embodiment 1

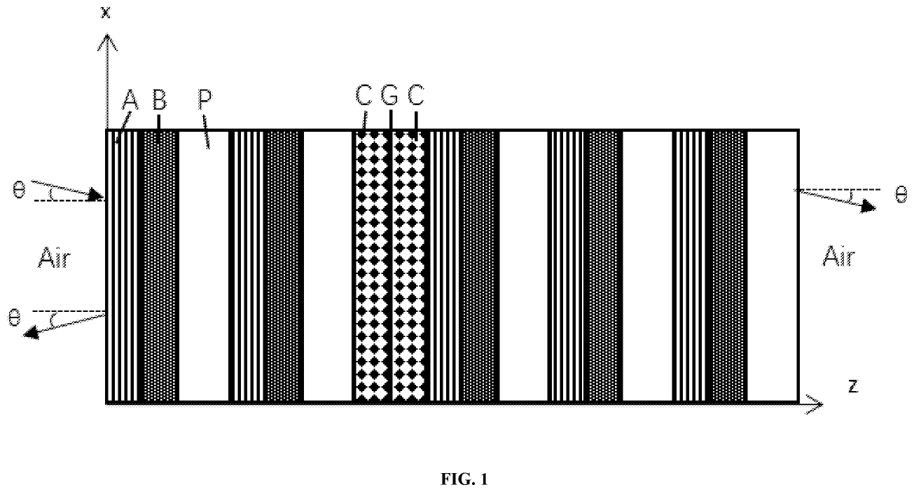

Referring to FIG. 1, a graphene-based optical bistable device with a ternary photonic crystal structure includes a ternary photonic crystal structure, a defect layer C, and a graphene layer G. The ternary photonic crystal structure is a periodic photonic crystal structure formed by three alternately-arranged dielectric layers A, B, and P with different dielectric constants. The dielectric layer A is made of a ZrO₂ material, the dielectric layer B is made of a Si material, and the dielectric layer P is made of an anisotropic plasma material. Two defect layers C are embedded in the ternary photonic crystal structure, and then the graphene layer G (film layer of graphene) is covered between the two defect layers C to form a composite structure Air/(ABP)^{N1}CG^{M}C(ABP)^{N2}/Air through permutation and combination, and the composite structure is suitable for a terahertz band.

In the above composite structure, M, N₁, and N₂ each represent a quantity of spatial cycles and are positive integers, (ABP)^{N} represents the ternary photonic crystal structure, a quantity of spatial cycles of the ternary photonic crystal on a left side of the defect layer C, namely, the N₁, is equal to 2, a quantity of spatial cycles of the ternary photonic crystal on a right side of the defect layer C, namely, the N₂, is equal to 3, and the M is equal to 1. A thickness of the dielectric layer A is 30 μm, a thickness of the dielectric layer B is 21.28 μm, and a thickness of the dielectric layer P is 60 μm. A thickness of the defect layer C is 30 μm, and a thickness of the graphene layer G is 0.33 nm. The defect layer C is filled with air and has a refractive index of n₀=1.

It should be noted that the above composite structure is placed in the air, and an electromagnetic wave is incident from a left side of the composite structure at a frequency of 0.91 THz. Herein, an ambient temperature is set to 300K, a Fermi level of the graphene layer G is set to 0.04 eV, relaxation time of the graphene layer G is set to 0.6 ps, and an initial graphene layer G is a monolayer graphene. For the dielectric layer P, a plasma electron density is 1e19m⁻³, a plasma collision frequency is 0 GHz, and an external magnetic field is set to OT.

It should also be noted that a relative dielectric constant of the dielectric layer A is εₐ=4.21 a relative dielectric constant of the dielectric layer B is ε_{b}=7.95, and a relative dielectric constant of the dielectric layer P is

$${ε}_{p} = ( \begin{matrix}{ε}_{1 p} & 0 & i {ε}_{2 p} \\ 0 & {ε}_{3 p} & 0 \\ - i {ε}_{2 p} & 0 & {ε}_{1 p}\end{matrix} ) .$$

In the above formula,

$${ε}_{1 p} = 1 - \frac{{ω}_{p}^{2} ( ω + {iv}_{c} )}{ω [ {( ω + {iv}_{c} )}^{2} - {ω}_{c}^{2} ]} , {ε}_{2 p} = 1 - \frac{{ω}_{p}^{2} {ω}_{c}}{ω [ {( ω + {iv}_{c} )}^{2} - {ω}_{c}^{2} ]} , and {ε}_{3 p} = 1 - \frac{{ω}_{p}^{2}}{{ω ( ω + {iv}_{c} )}^{2}} .$$

Finally, a dielectric constant of a plasma layer can be expressed as

$${ε}_{p} = \frac{{ε}_{1 p}^{2} - {ε}_{2 p}^{2}}{{ε}_{1 p}} = \frac{{[ ω ( ω + {iv}_{c} ) - {ω}_{p}^{2} ]}^{2} - {ω}_{c}^{2} {ω}^{2}}{{ω}^{2} [ ( ω + {iv}_{c} ) - {ω}_{c}^{2} ] - {ωω}_{p}^{2} ( ω + {iv}_{c} )} .$$

In the above formula, i represents an imaginary unit, where i²=−1; ω represents an incident angle frequency; and

$${ω}_{p} = \sqrt{\frac{{n}_{e} {e}^{2}}{m {ε}_{0}}}$$

represents a plasma frequency, where nₑ represents a plasma density, e represents a quantity of electron charges, m represents an electron mass, and ε₀ represents a vacuum dielectric constant; v_{c} represents the plasma collision frequency;

$${ω}_{c} = \frac{eB}{m}$$

represents an electron cyclotron frequency; and B represents a magnetic field intensity.

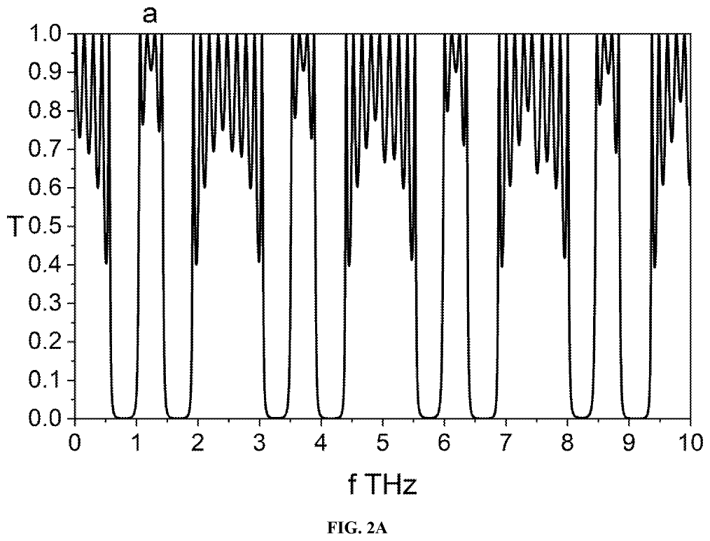

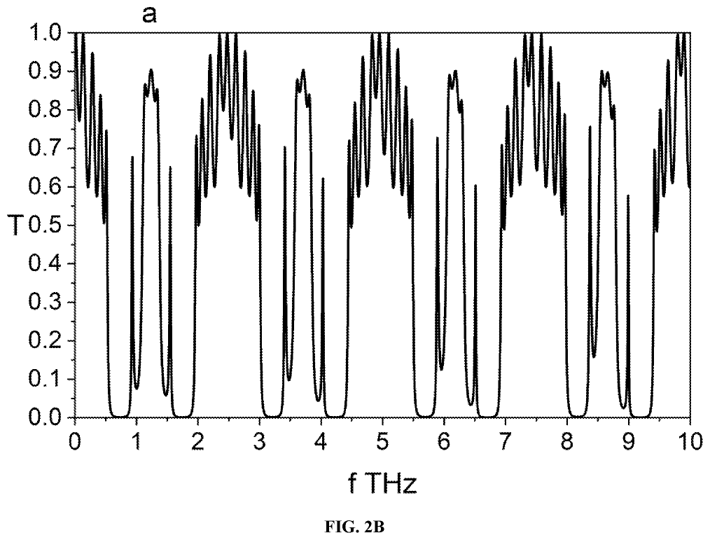

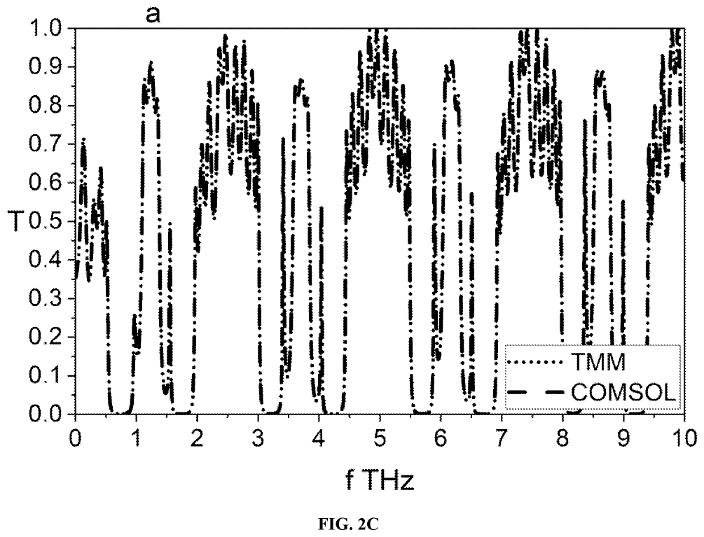

FIG. 2A is a photonic bandgap diagram of a one-dimensional ternary photonic crystal (ABP)^{N} in a terahertz band when the electromagnetic wave is vertically incident. The incident wave is incident from the left side of the composite structure. There are four forbidden bands in the terahertz band, and there is a relatively short passband region a in each forbidden band.

FIG. 2B is a photonic bandgap diagram of a composite structure (ABP)^{N1}CC(ABP)^{N2} with a defect mode embedded in the one-dimensional ternary photonic crystal. A defect mode transmission peak is separately formed on left and right sides of a region a in the photonic bandgap diagram, and a transmission peak on the left side of the region a in each forbidden band is greater than that on the right side of the region a in each forbidden band. In the four forbidden bands, the transmission peak on the left side of the region a increases with an increase of a quantity of forbidden bands, while the transmission peak on the right side of the region a decreases with the increase of the quantity of forbidden bands.

FIG. 2C is a photonic bandgap diagram of the composite structure (ABP)^{N1}CG^{M}C(ABP)^{N2} designed in the present disclosure. A black dotted line represents a calculation result of a transfer matrix method, and a gray dashed line represents a simulation result of the above structure in COMSOL software. From the figure, it can be observed that the two curves are quite consistent, and the simulation result in the COMSOL software verifies correctness of the transfer matrix method used in this specification. An absorption rate of the graphene reduces transmittance of the entire photonic bandgap diagram, and a transmission peak on a left side of a first forbidden band region a is significantly reduced.

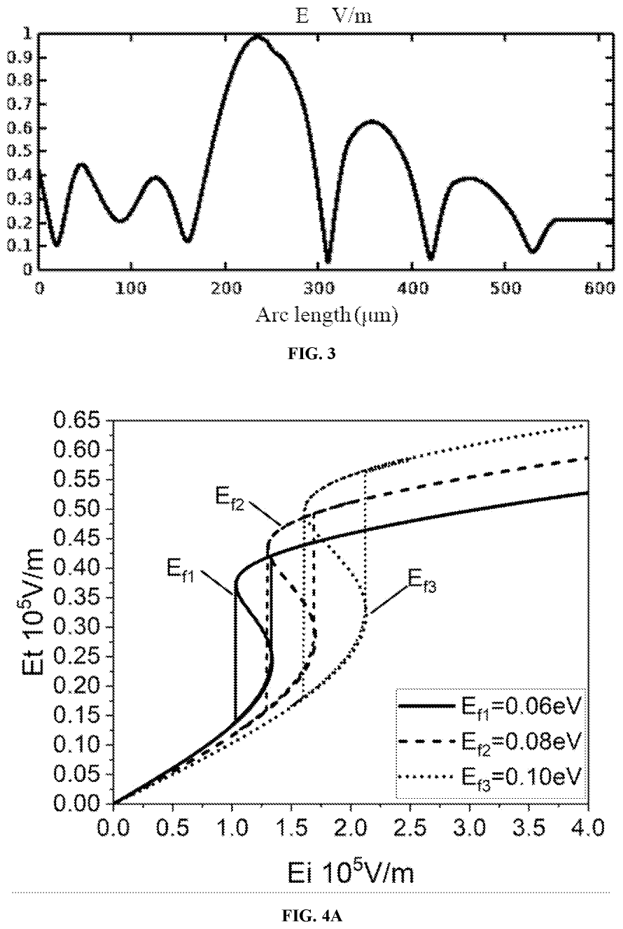

As shown in FIG. 3, a vertical axis represents a normalized electric field intensity. A film of the graphene is located at a strongest point of a local electric field. According to a graphene conductivity formula σ=σ₀+σ₃|E|², a third-order nonlinear effect of the graphene is enhanced with enhancement of the local electric field.

It should be noted that, without considering a change to the graphene due to the external magnetic field, conductivity of the graphene is composed of linear conductivity and nonlinear conductivity, namely, σ=σ₀+σ₃|E|². In the above formula, E represents a field value of a parallel electric field parallel to a graphene interface, σ₀ represents the linear conductivity, and σ₃ represents the nonlinear conductivity. The linear conductivity of the graphene is equal to inter-band conductivity plus intra-band conductivity, namely, σ₀=σᵢₙₜₑᵣ+σᵢₙₜᵣₐ.

The inter-band conductivity and the intra-band conductivity are respectively represented as follows:

$${σ}_{i n t e r} = \frac{i {e}^{2}}{4 πℏ} \vert \frac{2 {E}_{F} - ( ω + i {τ}^{- 1} ) ℏ}{2 {E}_{F} + ( ω + i {τ}^{- 1} ) ℏ} \vert , and {σ}_{i n t r a} = \frac{i {e}^{2} {k}_{B} T}{π {ℏ}^{2} ( ω + i / τ )} ( \frac{{E}_{F}}{{k}_{B} T} + 2 ln ( {e}^{- \frac{{E}_{F}}{{k}_{B} T}} + 1 ) )$$

In the above formulas, i represents the imaginary unit, where i²=−1; π represents a Pi constant; e represents the quantity of electron charges; ω represents the incident angle frequency; E_{F} represents a Fermi level of the graphene; τ represents relaxation time of the graphene; k_{B} represents a Boltzmann constant; T represents a temperature; h represents a Planck constant; and ℏ represents a reduced Planck constant.

When the graphene has a fewer layers, a layer quantity of the graphene directly and proportionally affects an intensity of a nonlinear effect. Third-order nonlinear conductivity of the graphene is

$${σ}_{3} = - i \frac{9}{8} \frac{{e}^{4} {ν}_{F}^{2}}{{πℏ}^{2} {E}_{F} {ω}^{3}} ,$$

and a Fermi velocity of an electron is ν_{F}≈10⁶ m/s.

It should also be noted that in a graphene-plasma photonic crystal composite structure, expressions of the electromagnetic wave in regions of the plasma layer and an ordinary dielectric layer are as follows:

$${H}_{j , y} = [ {A}_{j} {e}^{{jk}_{j , z} z} + {B}_{j} {e}^{- {jk}_{j , z} z} ] {e}^{{jk}_{x} x}$$

$${E}_{j , x} = \frac{{k}_{j , z}}{{ωε}_{0} {ε}_{j}} [ {A}_{j} {e}^{j {k}_{j , z} z} - {B}_{j} {e}^{- {jk}_{j , z} z} ] {e}^{j {k}_{x} x}$$

$${E}_{j , z} = - \frac{{k}_{j , z}}{{ωε}_{0} {ε}_{j}} [ {A}_{j} {e}^{j {k}_{j , z} z} + {B}_{j} {e}^{- {jk}_{z} z} ] {e}^{j {k}_{x} x}$$

In the above expressions, a z-axis is selected as a propagation direction, H_{j,y} represents a magnetic field intensity of a y-direction component of a TM wave in a dielectric, E_{j,x} represents an electric field intensity of an x-direction component of the TM wave in the dielectric, and E_{j,z} represents an electric field intensity of a z-direction component of the TM wave in the dielectric. Aⱼ and Bⱼ respectively represent amplitudes of an incident electric field and a reflected electric field in a j^{th} dielectric layer. z=0,dₐ,d_{b}+dₐ, . . . (dₐ+d_{b}+dₚ)×N+2×d_{c} represents a position of the electromagnetic wave on an interface between two different dielectrics, starting from a first layer interface z=0 and ending with (dₐ+d_{b}+dₚ)×N+2×d_{c}, and N represents a quantity of spatial cycles of the one-dimensional ternary photonic crystal. x=0 represents a position of the electromagnetic wave in an x direction,

$${k}_{x} = \frac{ω}{c} cos {θ}_{0}$$

represents an x component of a wave vector, ω represents the incident angle frequency, and ε₀ represents the vacuum dielectric constant. A z component of the wave vector in each dielectric layer is represented as

$${k}_{j , z} = \frac{ω}{c} \sqrt{{ε}_{j}} \sqrt{{μ}_{j}} \sqrt{1 - \frac{sin {θ}_{0}}{{ε}_{j} {μ}_{j}}} ,$$

where εⱼ and μⱼ respectively represent a relative dielectric constant and magnetic permeability of a material of the j^{th} dielectric layer, ω represents the incident angle frequency, c represents a vacuum light speed, and θ₀ represents an incident angle of the electromagnetic wave.

In the above structure, there are boundary conditions E_{j,x}=E_{j+1,x} H_{j,y}, H_{j+1,y} on an ordinary interface of the dielectric layer. An interface containing a two-dimensional material, namely, the graphene, has boundary conditions E_{j,x}=E_{j+1,x} H_{j+1,y}−H_{j,y}=−σ₈E_{j+1,x}. Based on the boundary conditions, an electric field relationship at different interfaces is organized as follows:

$$( \begin{matrix}{E}_{j}^{+} \\ {E}_{j}^{-}\end{matrix} ) = \frac{1}{2} ( \begin{matrix}1 + \frac{{k}_{j , z} {ε}_{j + 1}}{{k}_{j + 1 , z} {ε}_{j}} + \frac{{k}_{j , z} σ}{ω {ε}_{0} {ε}_{j}} & 1 - \frac{{k}_{j , z} {ε}_{j + 1}}{{k}_{j + 1 , z} {ε}_{j}} + \frac{{k}_{j , z} σ}{{ωε}_{0} {ε}_{j}} \\ 1 - \frac{{k}_{j , z} {ε}_{j + 1}}{{k}_{j + 1 , z} {ε}_{j}} - \frac{{k}_{j , z} σ}{ω {ε}_{0} {ε}_{j}} & 1 + \frac{{k}_{j , z} {ε}_{j + 1}}{{k}_{j + 1 , z} {ε}_{j}} - \frac{{k}_{j , z} σ}{{ωε}_{0} {ε}_{j}}\end{matrix} ) ( \begin{matrix}{E}_{j + 1}^{+} \\ {E}_{j + 1}^{-}\end{matrix} )$$

In the above formula, Eⱼ⁺ and Eⱼ⁻ respectively represent amplitudes of the incident electric field and the reflected electric field in the j^{th} dielectric layer, ω represents the incident angle frequency, k_{j,z} represents a z component of a wave vector of the electromagnetic wave in the j^{th} dielectric layer, ε₀ represents the vacuum dielectric constant, εⱼ represents the relative dielectric constant of the material of the j^{th} dielectric layer, σ represents conductivity on an interface of two dielectric materials, with σ=0 for an ordinary dielectric material and σ=σ₀+σ₃|E|² on a two-dimensional graphene interface, and E represents an electric field value on the graphene interface.

When a wave is propagated within the jₜₕ dielectric layer for a distance of dⱼ, only a phase size is changed, a propagation matrix Mⱼ of an electromagnetic wave within a dielectric layer is expressed as

$${M}_{j} = ( \begin{matrix}{e}^{- {ik}_{j , z} {d}_{j}} & 0 \\ 0 & {e}^{i {k}_{j , z} {d}_{j}}\end{matrix} ) ,$$

where i represents the imaginary unit, with i²=−1, e represents a natural constant, and k_{j,z} represents the z component of the wave vector of the electromagnetic wave in the j^{th} dielectric layer. Therefore, an expression of a relationship between an electric field and a transmitted electric field on the graphene interface can be obtained, namely,

$$E = ( \begin{matrix}1 & 1\end{matrix} ) {M}_{a} {D}_{a , b} … {M}_{p} {D}_{p , 0} ( \begin{matrix}{E}_{t}^{+} \\ 0\end{matrix} ) .$$

In the above expression, Mₐ, M_{b}, Mₚ, and M_{c} respectively represent propagation matrices of the electromagnetic wave in the dielectric layers A, B, P, and C, and D_{a,b} represents a propagation matrix of the electromagnetic wave from the dielectric layer A to an interface of the dielectric layer B. Similarly, D_{b,p} and D_{p,a} are also propagation matrices of two types of dielectric interfaces in the structure, and D_{p,0} represents a propagation matrix of the electromagnetic wave from the dielectric layer P to an air interface. E represents the electric field value on the graphene interface, and Eₜ⁺ represents a transmitted electric field of the composite structure.

An electric field E_{g} at a position of the graphene can be determined based on a boundary condition and an inverse transfer matrix of the two-dimensional material. Based on other boundary conditions, a relational expression of a transmitted electric field Eₜ and an incident electric field Eᵢ, and a relational expression of reflectivity R and the incident electric field Eᵢ can be determined.

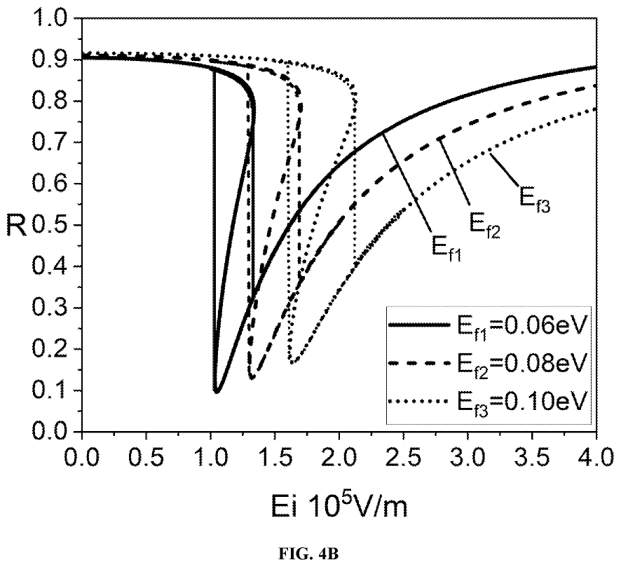

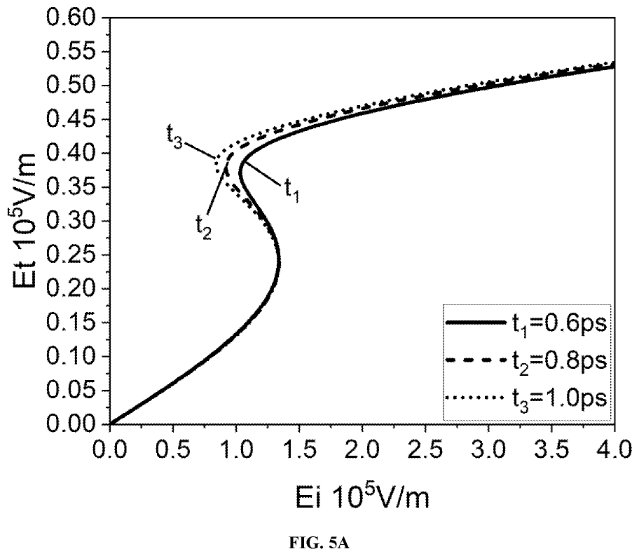

Referring to FIGS. 4A-4B, the Fermi level of the graphene is changed. FIG. 4A shows optical bistable hysteresis loops that are between the Eₜ and the Eᵢ and are obtained through computational analysis and simulation when the Fermi level of the graphene is 0.04 eV, 0.05 eV, and 0.06 eV, and FIG. 4B shows optical bistable hysteresis loops that are between the R and the Eᵢ and obtained through the computational analysis and the simulation when the Fermi level of the graphene is 0.04 eV, 0.05 eV, and 0.06. In the figures, a solid line represents a computational analysis result, while a dashed line represents a COMSOL simulation result. As the Fermi level of the graphene increases, both a bistable excitation threshold and a bistable shutdown threshold increase. An increase amplitude of the bistable excitation threshold shutdown threshold is less than that of the bistable excitation threshold excitation threshold, such that a bistable threshold width increases.

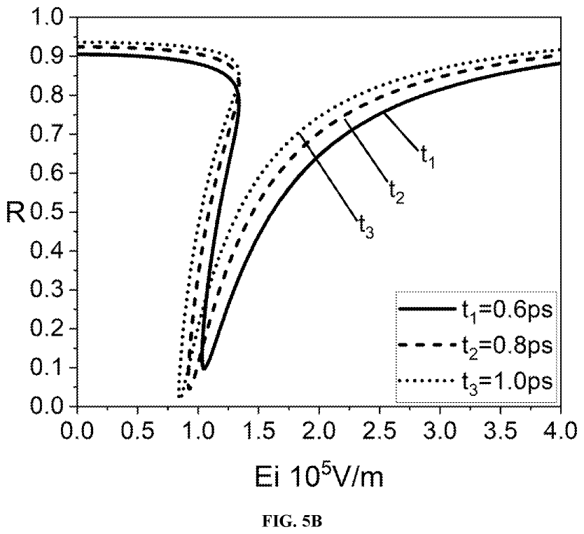

Referring to FIGS. 5A-5B, the relaxation time of the graphene is changed. FIG. 5A shows optical bistable curves that are between the Eₜ and the Eᵢ and are obtained through the computational analysis when the relaxation time of the graphene is 0.6 ps, 0.8 ps, and 1.0 ps, and FIG. 5B shows optical bistable curves that are between the R and the Eᵢ and are obtained through the computational analysis when the relaxation time of the graphene is 0.6 ps, 0.8 ps, and 1.0 ps. As the relaxation time of the graphene increases, the bistable excitation threshold increases slightly, the bistable shutdown threshold decreases, and the bistable threshold width increases significantly. As the relaxation time of graphene increases, a value of the transmitted electric field in FIG. 5A increases slightly, while reflectivity of an optical bistable phenomenon excited by the structure in FIG. 5B gradually decreases.

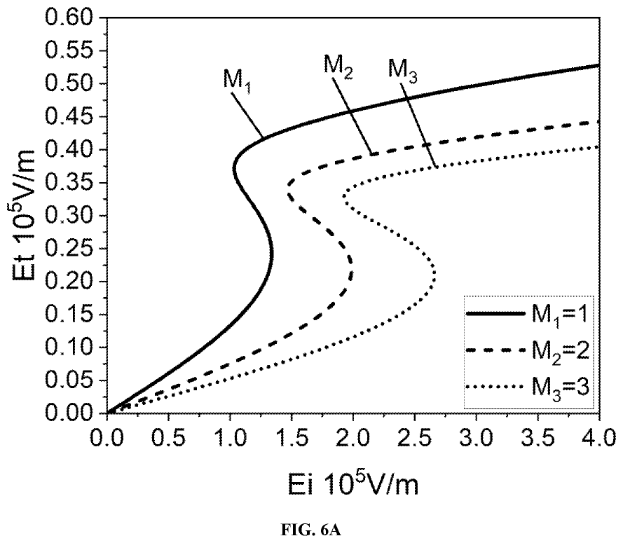

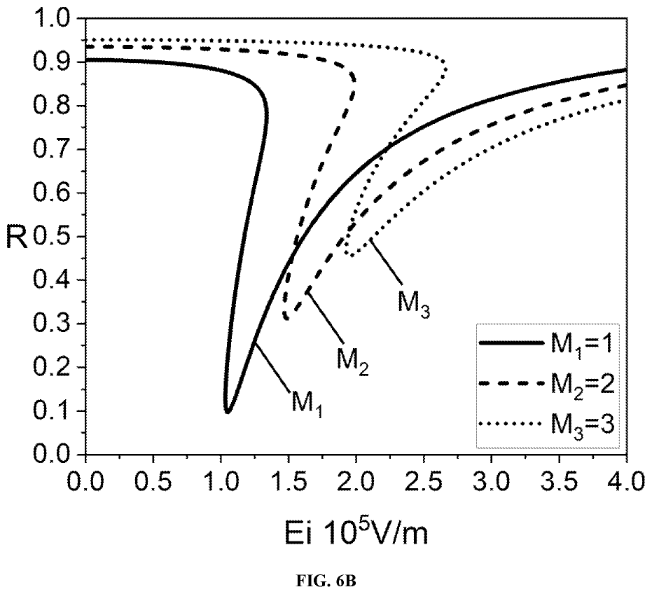

Referring to FIGS. 6A-6B, a film layer quantity of the graphene is changed. A thickness of single-layer graphene is 0.33 nm. When the film layer quantity of the graphene meets N<6, the conductivity of the graphene can be approximated as follows: σ≈Nσ₀. FIGS. 6A-6B show optical bistable curves that are between the Eₜ and the Eᵢ and are obtained through the computational analysis, and optical bistable curves that are between the R and the Eᵢ and are obtained through the computational analysis when the graphene has one, two, and three film layers. As the film layer quantity of the graphene increases, in the excited optical bistable phenomenon, an intensity of the transmitted electric field in FIG. 6A gradually decreases, and reflectivity in FIG. 6B increases. As the film layer quantity of the graphene increases, both the bistable excitation threshold and the bistable shutdown threshold increase. However, the increase amplitude of the bistable excitation threshold is greater than that of the bistable shutdown threshold, increasing the optical bistable threshold width and expanding an optical bistable operating range. From the above analysis, it can be seen that the bistable threshold and the bistable threshold width can be controlled by the Fermi level, the relaxation time, and the layer quantity of the graphene layer G.

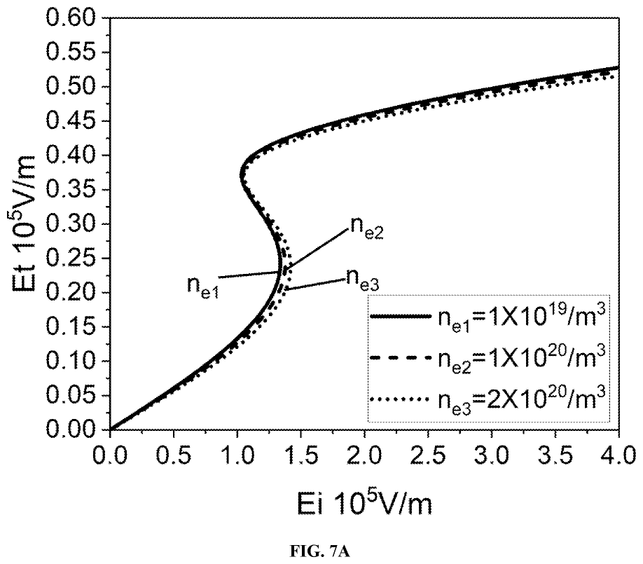

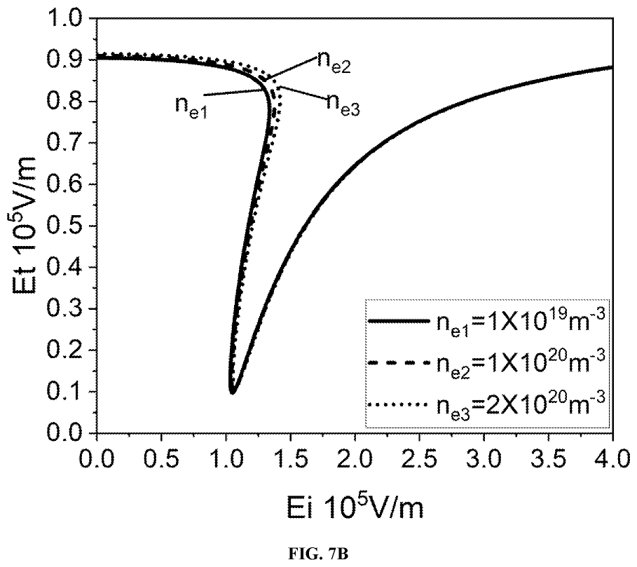

Referring to FIGS. 7A-7B, the plasma electron density of the dielectric layer P is changed. FIGS. 7A-7B show optical bistable curves that are between the Eₜ and the Eᵢ and are obtained through the computational analysis, and optical bistable curves that are between the R and the Eᵢ and are obtained through the computational analysis when the plasma electron density is nₑ=1e19m⁻³, nₑ=1e20m⁻³ and nₑ=2e20m⁻³. As the electron density increases, both the bistable excitation threshold and the bistable shutdown threshold increase, and threshold widths calculated based on result data are respectively 0.30×10⁵V/m, 0.33×10⁵V/m, and 0.36×10⁵V/m From this, it can be seen that as the electron density increases, the increase amplitude of the bistable excitation threshold is greater than that of the bistable shutdown threshold, resulting in a wider range between switching thresholds. Therefore, the bistable threshold and the bistable threshold width can be controlled by the plasma electron density of the dielectric layer P.

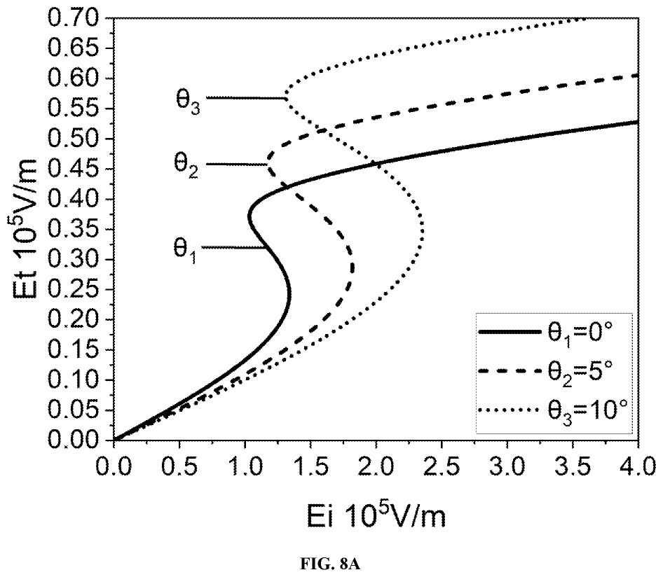

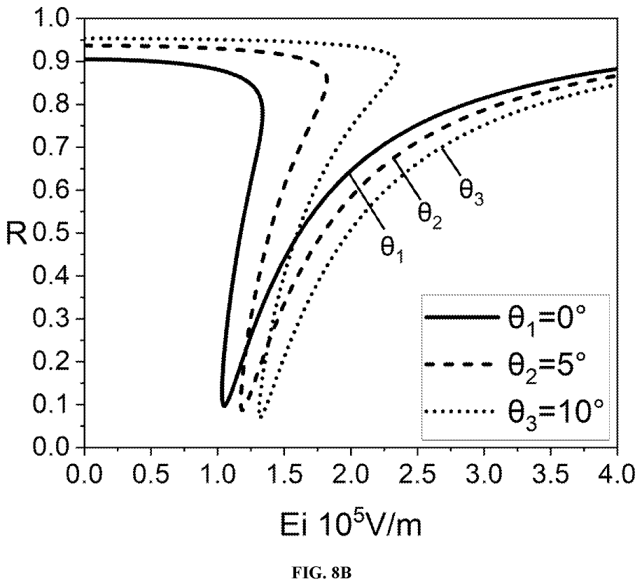

Referring to FIGS. 8A-8B, the incident angle of the electromagnetic wave is changed. When the incident angle is 0°, 5°, and 10°, optical bistable curves between the Eₜ and the Eᵢ, and optical bistable curves between the R and the Eᵢ are obtained through the computational analysis. As the incident angle increases, in the excited optical bistable phenomenon, an intensity of the transmitted electric field in FIG. 8A gradually increases, and reflectivity in FIG. 8B decreases. As the incident angle increases, both the bistable excitation threshold and the bistable shutdown threshold increase. However, the increase amplitude of the bistable excitation threshold is greater than that of the bistable shutdown threshold, increasing the optical bistable threshold width and expanding the optical bistable operating range. Therefore, the bistable threshold and the bistable threshold width can be controlled by the incident angle of the electromagnetic wave.

In conclusion, the composite structure in the present disclosure achieves a lower threshold with the help of an enhanced defect mode local field and a strong nonlinear effect of the graphene. The two types of metamaterials, namely, the plasma and the graphene, are added to the composite structure, such that optical bistability can be tuned by using a physical parameter of the plasma, a physical parameter of the optical bistability, and the incident angle of the electromagnetic wave. Moreover, the defect mode of the ternary photonic crystal structure is used to further reduce the excitation threshold of the optical bistable device. With advantages of a low threshold and lots of parameters that can be used to control the optical bistability, the present disclosure has stable working performance and a broad application prospect in terahertz-band devices.

Although the embodiments of the present disclosure have been illustrated and described, it should be understood that those of ordinary skill in the art may make various changes, modifications, replacements, and variations to the above embodiments without departing from the principle and spirit of the present disclosure, and the scope of the present disclosure is limited by the appended claims and their legal equivalents.

What is claimed is:

1. A graphene-based optical bistable device with a ternary photonic crystal structure, the graphene-based optical bistable device comprising:
a composite structure suitable for a terahertz band, wherein the composite structure is formed by a ternary photonic crystal structure, a defect layer C, and a graphene layer G through permutation and combination;
wherein the ternary photonic crystal structure is a periodic photonic crystal structure formed by three alternately-arranged dielectric layers A, B, and P with different dielectric constants, two defect layers C are embedded in the ternary photonic crystal structure, and the graphene layer G is embedded between the two defect layers C; wherein
wherein the composite structure is Air/(ABP)^{N1}CG^{M}C(ABP)^{N2}/Air wherein M, N₁, and N₂ each represent a quantity of spatial cycles, the dielectric layer A is made of a ZrO₂ material, the dielectric layer B is made of a Si material, and the dielectric layer P is made of an anisotropic plasma material.

2. The graphene-based optical bistable device with a ternary photonic crystal structure according to claim 1, wherein the defect layer C is filled with air and has a refractive index of n₀=1.

3. The graphene-based optical bistable device with a ternary photonic crystal structure according to claim 1, wherein a relative dielectric constant of the dielectric layer A is εₐ=4.21, a relative dielectric constant of the dielectric layer B is ε_{b}=7.95, and a relative dielectric constant of the dielectric layer P is
$${ε}_{p} = \frac{{[ ω ( ω + {iv}_{c} ) - {ω}_{p}^{2} ]}^{2} - {ω}_{c}^{2} {ω}^{2}}{{ω}^{2} [ ( ω + {iv}_{c} ) - {ω}_{c}^{2} ] - {ωω}_{p}^{2} ( ω + {iv}_{c} )} ;$$
wherein i represents an imaginary unit, wherein i²=−1; ω represents an incident angle frequency;
$${ω}_{p} = \sqrt{\frac{{n}_{e} {e}^{2}}{m {ε}_{0}}}$$
represents a plasma frequency, wherein nₑ represents a plasma density, e represents a quantity of electron charges, m represents an electron mass, and ε₀ represents a vacuum dielectric constant; v_{c} represents a plasma collision frequency;
$${ω}_{c} = \frac{eB}{m}$$
represents an electron cyclotron frequency; and B represents a magnetic field intensity.

4. The graphene-based optical bistable device with a ternary photonic crystal structure according to claim 1, wherein thicknesses of the layers in the composite structure are respectively as follows: dₐ=30 um, d_{b}=21.28 um, dₚ=60 um, d_{c}=30 um, and d_{g}=0.33 nm; and
M=1, N₁=2, and N₂=3.

5. The graphene-based optical bistable device with a ternary photonic crystal structure according to claim 1, wherein thresholds and a threshold difference of the bistable device are controlled by a Fermi level, relaxation time, and a layer quantity of the graphene layer G.

6. The graphene-based optical bistable device with a ternary photonic crystal structure according to claim 1, wherein thresholds and a threshold difference of the bistable device are controlled by a plasma electron density of the dielectric layer P.

7. The graphene-based optical bistable device with a ternary photonic crystal structure according to claim 1, wherein thresholds and a threshold difference of the bistable device are controlled by an incident angle of an electromagnetic wave.
